(19) United States
(12) Patent Application Publication
(10) Pub. No.: US 2025/0110034 A1
(43) Pub. Date: Apr. 3, 2025

(54) MATERIAL DENSITY INDEX

(71) Applicant: Topcon Positioning Systems, Inc., Livermore, CA (US)

(72) Inventors: James SCHNAIDER, Martensville (CA); Matthew PETRYSHYN, Hague (CA)

(73) Assignee: Topcon Positioning Systems, Inc., Livermore, CA (US)

(21) Appl. No.: 18/479,258

(22) Filed: Oct. 2, 2023

(51) Int. Cl. G01N 9/36; A01D 45/10

(52) U.S. Cl. CPC G01N 9/36; A01D 45/10

(57) ABSTRACT

Systems and methods are provided for determining a material density of a harvested crop. The method includes receiving a measurement of a first throughput signal; receiving a measurement of a second throughput signal, wherein the second throughput signal is more sensitive to changes in material density than the first throughput signal; comparing the first throughput signal to the second throughput signal; and determining a material density index value based on the comparison of the first throughput signal to the second throughput signal.

### BACKGROUND OF THE INVENTION

The present disclosure relates generally to estimating material density of material harvested by an agricultural machine.

Agricultural machines such as sugarcane harvesters, or any agricultural machine that performs any harvesting of material, harvest both the desired material as well as extraneous material such as leaves, etc.

For example, sugarcane harvesters cut sugarcane stalks near a soil level and chop those harvested sugarcane stalks into shorter lengths (referred to herein as billets) with a chopper mechanism. In this example, the sugarcane harvester separates the desired crop from extraneous material, including leaves, dirt, etc. and/or any other material that is collected but not the desired crop itself (referred to collectively as “trash”) from the cane stalk pieces using a fan, which causes the lighter trash material to be ejected from the harvesting stream, so that just the cane stalk pieces are collected. In some designs a second extractor fan can be included at the end of the conveyor to remove any trash material that moved past the first fan.

Most trash is removed by the first fan or the combination of the first fan and the second fan, however some trash will pass through to the elevator, which transmits the trash and cane stalk pieces from one location to another location for collection. This inclusion of trash affects the estimated material density since the trash itself could have a relatively large volume but small weight as compared to the cane stalk pieces.

Agricultural machine parameters (e.g., groundspeed) and crop conditions (e.g., moisture, variety) can affect the performance of the extractor system of the agricultural machine. If the first fan speed is increased to a relatively high level, this will cause the removal of more trash, but may also cause an increased amount of cane stalk pieces also being extracted. Conversely, if the first fan speed is decreased to a relatively low level, this will cause a higher amount of trash being collected and being a part of the estimate of material density, which creates an overestimate in the actual collection of the cane stalk pieces. This additional trash is also not desirable for handling by a mill, which will process both the cane stalk pieces and the trash.

Operators of agricultural machines can visually inspect what is being collected, and then manually adjust the fan speed in an attempt to maintain a certain amount of trash passing by the fan unremoved (e.g., a “trash target”). Trash targets, or changes to trash levels, can be visually monitored by an experienced operator, but any modification of fan speed would then need to occur manually.

### BRIEF SUMMARY OF THE INVENTION

In accordance with one or more embodiments, a method for determining a material density of a harvested crop is provided. This method includes receiving a measurement of a first throughput signal and receiving a measurement of a second throughput signal. In this method, second throughput signal is more sensitive to changes in material density than the first throughput signal. This difference is advantageous as the material density index can be a more accurate value through consideration of components that disproportionately impact volume estimates. The method includes comparing the first throughput signal to the second throughput signal then determining a material density index value based on the comparison of the first throughput signal to the second throughput signal.

In accordance with another embodiment, an agricultural machine that includes a processor and memory to perform the steps of determining a material density of a harvested crop is provided. In accordance with another embodiment, an agricultural machine that includes a waste sensor, a fan, a processor and memory to perform the steps of determining a material density of a harvested crop is provided.

These and other advantages of the invention will be apparent to those of ordinary skill in the art by reference to the following detailed description and the accompanying drawings.

### BRIEF DESCRIPTION OF THE DRAWINGS

FIG. 1 is a graphical illustration of an agricultural machine.

FIG. 2 is a flow chart of a method of the present disclosure.

FIG. 3 is a graphical illustration of a density index on the y axis and fan speed in rotations per minute on the x axis.

FIG. 4 is a graphical illustration of a density index on the y axis and percent mass error (volumetric-based) on the x axis.

FIG. 5 if shows a high-level block diagram of a computer for implementing components of the present disclosure, according to an embodiment.

### DETAILED DESCRIPTION

Embodiments described herein provide for methods, and machines in conjunction with methods, for determining a material density of a harvested crop. For that harvested crop, if trash throughput (and a resultant impact on material density) were measured according to the present disclosure, the throughput could be presented to the operator for manual adjustment to adjust fan speed, according to a method disclosed herein. This may be advantageous in the case of an unskilled operator. The material density measurement of the present disclosure may also be used for automation of various components of the agricultural machine, as discussed herein.

One embodiment of the present disclosure is directed to a method for determining a material density of a harvested crop. The harvested material can be any harvestable crop, including sugarcane, etc., which includes the desired crop for harvesting, as well trash. The material density is a value of the mass of the harvested crop, divided by its volume, with the trash typically having a lower density due to a relatively low mass to relatively large mass ratio. The inclusion of trash in the material density determination results in inaccurate determinations of the amount of the desired crop itself.

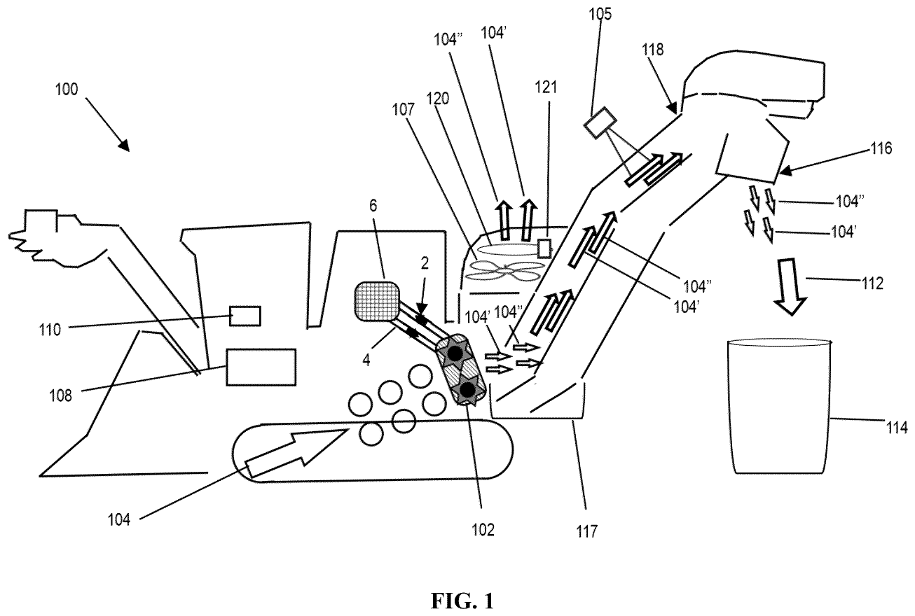

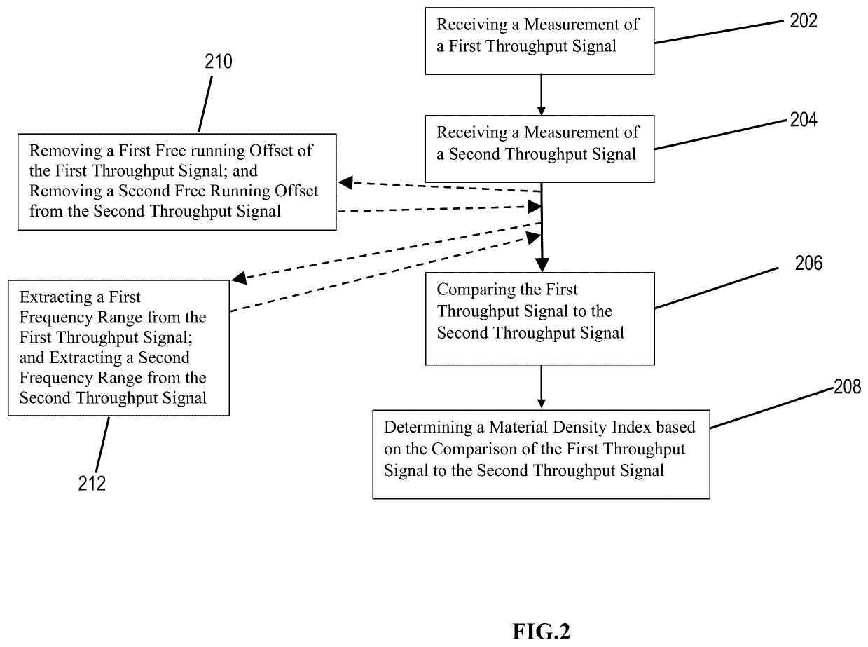

Determining the material density of a harvested crop of the present disclosure provides the advantage of reducing or removing the impact of trash from the determined material density of the harvested crop itself. The method of this determination is illustrated in FIG. 2, with the method being described in conjunction with an agricultural machine illustrated in FIG. 1.

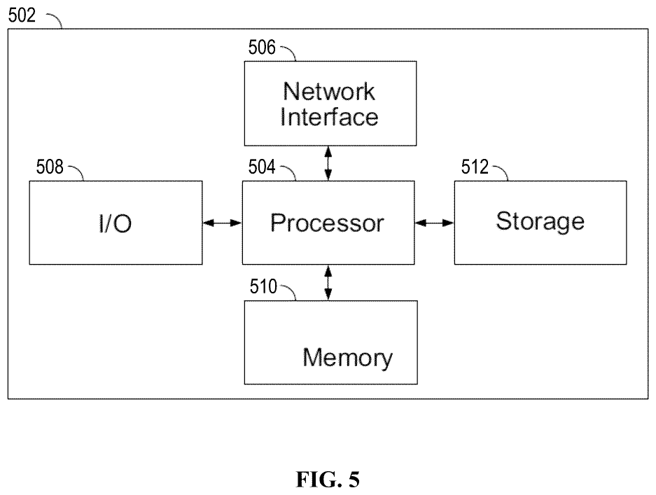

The method for determining a material density of a harvested crop includes step 202, of receiving a measurement of a first throughput signal of the harvested crop. The harvestable material 104, which is the material removed from a harvestable area or field, includes two components for consideration, the desired, harvested crop (referred to as 104′ herein) and trash (referred to as 104″ herein), which are substantially separated from each other during processing, as described herein. Thus, harvestable material 104=harvested crop 104′+trash 104″. The first throughput signal is measured using any suitable sensor and/or detector, and can be received by any suitable processor, such as the processor illustrated in FIG. 5 and discussed herein.

The first throughput signal can be any suitable signal that indicates the amount of harvested crop 104′ that has been harvested (which may include relatively small amounts of trash 104″). Examples of this first throughput signal include, but are not limited to: a weight of the harvested crop 104′ at a location in or on an agricultural machine 100, a weight of the harvested crop 104′ at a collection location 114, a processing power of a component of the agricultural machine 100. and/or a hydraulic pressure of the component of the agricultural machine 100, etc.

The agricultural machine 100 can be any suitable agricultural machine that is capable of harvesting the harvestable material 104, such as a sugarcane harvester.

Regarding the weight of the harvested crop 104′ at a location of the agricultural machine 100, that weight can be measured using any suitable weighing device, such as a mechanical or electrical scale, a load cell, a weighing coil, etc., at any suitable location of the agricultural machine 100. Any suitable location of the agricultural machine 100 includes, but is not limited to, a hopper 117 that temporarily stores harvested crop 104′ and/or a collection location such as a bin 114 that receives harvested crop 104′ from an outlet 116, along path 112. The bin 114 can be connected to the agricultural machine 100 itself or be transported together with the agricultural machine 100, such as on a wagon or trailer.

The first throughput signal received in Step 202 can also be received as the processing power of a component of the agricultural machine 100 that is measured with any suitable power sensor or power meter. The processing power of the component can be any suitable component utilized in the harvesting process, such as a chopper 102, with the processing power of the chopper 102 being delivered by hydraulic fluid 2 of the agricultural machine. Chopper 102 can be any suitable device that can break apart relatively large pieces of harvestable crop 106 into relatively smaller pieces.

The hydraulic fluid 2 of the agricultural machine is transmitted within a hydraulic circuit 4, the hydraulic circuit 4 comprising a hydraulic motor 6 configured to pump the hydraulic fluid 2 through the hydraulic circuit 4. As used herein the term “hydraulic circuit” and “hydraulic conduit” means any piping and/or hose elements configured to have hydraulic fluid within them. The hydraulic conduit may be composed of any suitable material, such as metals, plastics, rubbers, carbon-based materials, etc. and combinations thereof. For other components of the agricultural machine 100 other than the chopper 102, the processing power can be any electrical, mechanical and/or hydraulic power drawn by the component to operate.

Additionally, the first throughput signal received in Step 202 can also be received as a hydraulic pressure measurement of the hydraulic fluid 2 at any suitable location within the hydraulic circuit 4, including in or adjacent to any of the components (such as chopper 102) of the agricultural machine 100. The hydraulic pressure can be measured using any suitable pressure detector such as a pressure sensor, a manometer, a pressure transducer, a gauge, an anemometer, etc., and combinations thereof.

Subsequently, the method for determining a material density of a harvested crop includes step 204, of receiving a measurement of a second throughput signal of the harvested crop. As compared to the first throughput signal received in step 202, the second throughput signal received in step 204 is any other value measurable during harvesting that is more sensitive to changes in material density. The second throughput signal is measured using any suitable sensor and/or detector, and can be received by any suitable processor, such as the processor illustrated in FIG. 5 and discussed herein. Examples of the second throughput signal are a volume throughput of the harvestable material 104 at a location of the agricultural machine 100 and a volume throughput of the harvestable material 104 at a collection location.

The second throughput signal is more sensitive to changes in material density than the first throughput signal is since signals based on volume estimates include the volume of both the harvested crop 104′ and the trash 104″. The trash 104″ has a larger impact on volume due to the relatively large size (volume) to relatively low weight (low density) of the trash 104″. Thus, volume-based signals such as the second throughput signal are impacted to a larger degree by trash 104″ presence as compared to measurements, such as the first throughput signal, which are affected by trash 104″ presence to a lesser degree.

The volume throughput of the harvestable material 104 includes the volume of the harvested crop 104′, and also may include volume of trash 104″, with the volume of the harvested crop 104′ and trash 104″ being measured using any suitable volume measuring device, such as a volume flow sensor 105. The volume flow sensor 105 can be any suitable sensor and/or detector, such as an ultrasonic volume sensor (or other suitable volume sensor such as a suitable camera and/or a light detection and ranging (LIDAR) sensor), an acoustic volume sensor, etc. and combinations thereof.

Although volume flow sensor 105 is shown in one location of FIG. 1, the volume flow sensor 105 (or any other volume measuring device) can be at any suitable location of the agricultural machine 100 for sensing volume. Suitable locations of the agricultural machine 100 include, but are not limited to, a hopper 117 that temporarily stores harvested crop 104′, and/or along a transport mechanism 118 between the hopper 117 and the outlet 116, and/or a collection location such as the bin 114 that receives harvested crop 104′ from the outlet 116, along path 112. The transport mechanism 118 can be any suitable conveyor system and/or belt system that is configured to move harvested crop 104′ from one location within the agricultural machine 100 to another location.

Subsequently, the method for determining a material density of a harvested crop includes step 206, of comparing the first throughput signal of step 202 to the second throughput signal of Step 204. This comparison can be conducted by any suitable processor, such as the processor illustrated in FIG. 5 and discussed herein.

The result of the comparison is the determination of a material density index value in step 208.

The comparison of the first throughput signal of step 202 to the second throughput signal of Step 204 in Step 206 to determine the material density index value in step 208 can be done in any suitable way, such as Equation 1:

$$Density Index Value = \frac{( first throughput signal - second throughput signal )}{( first throughput signal + second throughput signal )}$$

Another Example of the comparison of the first throughput signal of step 202 to the second throughput signal of Step 204 in Step 206 to determine the material density index value in step 208 is another suitable way of Equation 2:

$$Density Index Value = \frac{first throughput signal}{second throughput signal}$$

The determination of the material density index value in step 208 is a value indicative of material density changes during a harvesting operation, which can be used to estimate the amount of actually harvested harvested crop 104′ as opposed to typical estimates which include the amount of actually harvested harvested crop 104′ and the amount of actually harvested trash 104″.

Optionally, prior to Step 206, the method for determining a material density of a harvested crop can include the optional step 210 of removing a first free running offset of the first throughput signal of Step S02; and/or removing a second free running offset from the second throughput signal of Step 204. The free running offset is a reduction from one or both of the first throughput signal of Step 202 and the second throughput signal of Step 204 of the signal (such as an energy, a volume signal, etc.) used to operate a component itself of the agricultural machine 100 that is associated with one or both of the first throughput signal of Step 202 and the second throughput signal of Step 204. The free running offset is when that component is operating at idle, which occurs when the component is not under a load, e.g. neither processing a material nor causing the machine to move or operate but the component is receiving power and rotating. The offset for free running can be referred to as, e.g. an offset for “zero-throughput power” or “idle load”. For example, a free running offset the chopper 102 can be removed from the first throughput signal.

An example of the optional step 210 can be seen in Equations 3 and 4 below.

$$First Throughput {signal}^{′} = ( First Throughput Signal ) - ( Free Running Offset of Associated Component ) \qquad Equation 3$$

$$Second Throughput {signal}^{′} = ( Second Throughput Signal ) - ( Free Running Offset of Associated Component ) \qquad Equation 4$$

In Equations 3 and 4 the first throughput signal′ and the second throughput signal′ more accurately value the signal received due to the processing of the harvestable material 104 itself, without including the energy demands of the components themselves. The first throughput signal′ and the second throughput signal′ values can then be used for the remainder of the disclosed method.

Another example of the optional step 210 is seen in Equations 5 and 6 below, which calculates a derivative of the first throughput signal (First Throughput signal′) of step 202 and calculates a derivative of the second throughput signal (Second Throughput signal′) of step 204 to remove the free running offset, rather than subtract the free running offset as seen in Equations 3 and 4.

$$First Throughput {signal}^{′} = \frac{Change in the First Throughput Signal}{Change in Time} \qquad Equation 5$$

$$Second Throughput {signal}^{′} = \frac{Change in the Second Throughput Signal}{Change in Time} \qquad Equation 6$$

Equations 5 and 6 may also be used to remove the first free running offset of the first throughput signal of Step 202; and/or removing a second free running offset from the second throughput signal of Step 204, for any period of time first throughput signal and/or the second throughput signal is measured.

In Equations 5 and 6 the first throughput signal′ and the second throughput signal′ more accurately value the signal received due to the processing of the harvestable material 104 itself, without including the energy demands of the components themselves. The first throughput signal′ and the second throughput signal′ values can then be used for the remainder of the disclosed method.

Subsequent to optional step 210, the method can continue with step 206 with the modified first throughput signal and the modified second throughput signal. Thus, in this embodiment, the order of steps is 202, 204, 210, 206, and 208.

Optionally, prior to Step 206, the method for determining a material density of a harvested crop can include the optional step 212 of extracting a first frequency range from the first throughout signal of Step 202; and extracting a second frequency range from the second throughput signal of Step 204. In this optional step 206, only certain frequencies of each of the first throughput signal and the second throughput signal can be used for the comparison step 206.

The extraction of the first frequency range(s) from the first throughout signal of Step 202 and the extraction of the second frequency range(s) from the second throughput signal of Step 204 can happen in any suitable way. These suitable ways include suitable physical ways of passing the first throughput signal of Step 202 and the second throughput signal of Step 204 through one or more high-pass filters and/or one or more band-pass filters and/or suitable software based ways, such as operating a program with the computer of FIG. 5 to extract portion(s) of the first frequency range(s) from the first throughout signal of Step 202 and extract portion(s) of the second frequency range(s) from the second throughput signal of Step 204.

This extraction of Step 212 removes baseline values (“frequency=0), which can represent the free running offset from both the first throughout signal of Step 202 and from the second throughput signal of Step 204. The extraction of the first frequency range(s) from the first throughout signal of Step 202 is shown in Equation 7 below.

$$First Throughput {signal}^{′} = bandpass [ First Throughput Signal ] \qquad Equation 7$$

The extraction of the second frequency range(s) from the second throughout signal of Step 204 is shown in Equation 8 below.

$$Second Throughput {signal}^{′} = bandpass [ Second Throughput Signal ] \qquad Equation 8$$

In Equations 7 and 8 the first throughput signal′ and the second throughput signal′ more accurately value the signal received due to the processing of the harvestable material 104 itself, without including the energy demands of the components themselves. The first throughput signal′ and the second throughput signal′ values can then be used for the remainder of the disclosed method.

Subsequent to optional step 212, the method can continue with step 206 with the modified first throughput signal and the modified second throughput signal. Thus, in this embodiment, the order of steps is 202, 204, 212, 206, and 208.

The agricultural machine 100 can also include, e.g., an engine 108. Engine 108 can be any suitable fuel powered engine, such as a gasoline or diesel engine, any suitable electrically powered engine, such as an electromagnetic motor, and combinations thereof. The engine 108 is configured to produce power and drive the agricultural machine 100 forward and/or reverse, so that the agricultural machine 100 can perform harvesting operations.

The agricultural machine 100 can also include a processor 110. Processor 110 can be a suitable hardware processor, such as be processor 504 noted in reference to FIG. 5 below, and/or can operate together with processor 504 noted in reference to FIG. 5 below. Processor 110 can include a transceiver to transmit data and/or receive data from any remote processors. The processor 110 alone and/or in conjunction with any remote processor(s) can be configured to interact with the agricultural machine 100 and perform the methods disclosed herein. For example, the processor 110 can automatically change the ground speed of the agricultural machine 100 by controlling the power of the engine 108 and/or by controlling a transmission (not shown) of the agricultural machine 100.

The agricultural machine can also include a fan 107. As disclosed herein, the term “fan” refers to any apparatus capable of delivery of a quantity of a gas, such as air, these apparatus including but not limited to rotating blades or fins, a nozzle configured to deliver a quantity of a gas, a turbine, a blower, etc. and combinations thereof. The processor 110 alone and/or in conjunction with any remote processor(s) can be configured automatically to change a delivered quantity of air from the fan 107 based on the determined material density index value resulting from Step 208. The automatic change can be to certain, predetermined values, or can occur in a step-wise manner.

The determined material density index value of step 208 is indicative of the density of the harvested crop 104′, which has a higher mass to volume ratio as compared to the mass to volume ration of the trash 104″. Therefore, when the determined material density index value of step 208 is above a threshold, this indicates that the amount of trash 104″ is relatively low and the quantity of air can be changed to decrease. Conversely, when the determined material density index value of step 208 is below a threshold, this indicates that the amount of trash 104″ is relatively high and the quantity of air can be changed to increase so that more trash 104″ is removed from the agricultural machine 100 through a trash outlet 120.

The quantity of delivered air is configured to remove at least a portion of the trash 104″ because the trash 104″ has a relatively low mass to volume ratio and is expected to be positionally influenced to a greater degree as compared to the harvested crop 104′ based on the quantity of air contacting the both the harvested crop 104′ and the trash 104″. However, if a quantity of delivered air can be so large that not only does trash 104″ exit the agricultural machine 100 through the trash outlet 120, a quantity of harvested crop 104′ can also be caused to exit. This situation is preferably avoided because the harvested crop 104′ that passes through the trash outlet 120 is not collected and is lost to the stream of commerce.

To avoid and/or reduce a quantity of harvested crop 104′ exiting the trash outlet 120, the agricultural machine 100 can receive a waste signal. The waste signal can be received by any suitable processor, such as the processor illustrated in FIG. 5 and discussed herein.

The waste signal can be generated by any suitable waste sensor and/or waste detector, such as waste sensor 121. Examples of waste sensor 121 can be an optical sensor, in conjunction with by any suitable processor, such as the processor illustrated in FIG. 5 and discussed herein, with that optical sensor being configured to differentiate the elements passing through the trash outlet 120 as trash 104″ or harvested crop 104′.

Thus, when a waste signal is received that indicates harvested crop 104′ is passing through the trash outlet 120, the delivered quantity of air can be automatically reduced to a predetermined value and/or in step-wise manner.

### EXAMPLES

The disclosure is further described by the following examples, which are not intended to limit the scope of the invention recited in the claims.

### Example 1

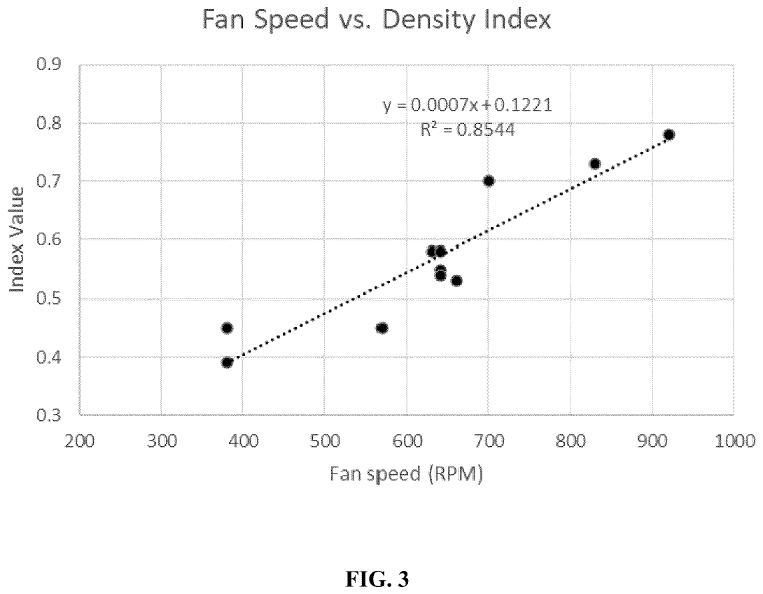

By varying the quantity of air from the fan 107, the amount of trash 104″ passing through the trash outlet 120 can be adjusted, which varies the density of the overall mixture of trash 104″ and harvested crop 104′ passing through the outlet 116, with more quantity of air causing an increase in density due to more removal of relatively low density trash 104″. Therefore, the determined a material density index value in step 208 can change in response to the quantity or air as shown in FIG. 3, which includes a density index on the y axis, fan speed (or quantity of air) on the x axis, and data points, which when can be linearly fit to represent a relationship between the two variables.

The results of FIG. 3 are produced by Equation 9 below:

$$Density Index Value = \frac{( first throughput {signal}^{′} - second throughput {signal}^{′} )}{( first throughput {signal}^{′} + second throughput {signal}^{′} )} \qquad Equation 9$$

In Equation 9, both the first throughput signal′ and the second throughput signal′ has undergone removal of their respective free running offsets, as discussed above.

### Example 2

Density of the overall mixture of trash 104″ and harvested crop 104′ passing through the outlet 116 is influenced by the quantity of air produced by fan 107. Density of the overall mixture of trash 104″ and harvested crop 104′ passing through the outlet 116 can create a difference in mass estimate of what enters the collection location/bin 117. For example, if 100 cubic feet of mixture of trash 104″ and harvested crop 104′ enter the collection location/bin 117, and the mass estimate is based on a density of the harvested crop 104′ alone, the trash 104″ volume will be mistakenly considered the same density of harvested crop 104′, which will result in an actual mass of harvested crop 104′ in that 100 cubic feet to be less than expected.

Therefore, the determined material density index value in step 208 can be used to more accurately predict volume-based mass error because the actual, overall density of the mixture of trash 104″ and harvested crop 104′ entering the collection location/bin 117 will have been determined.

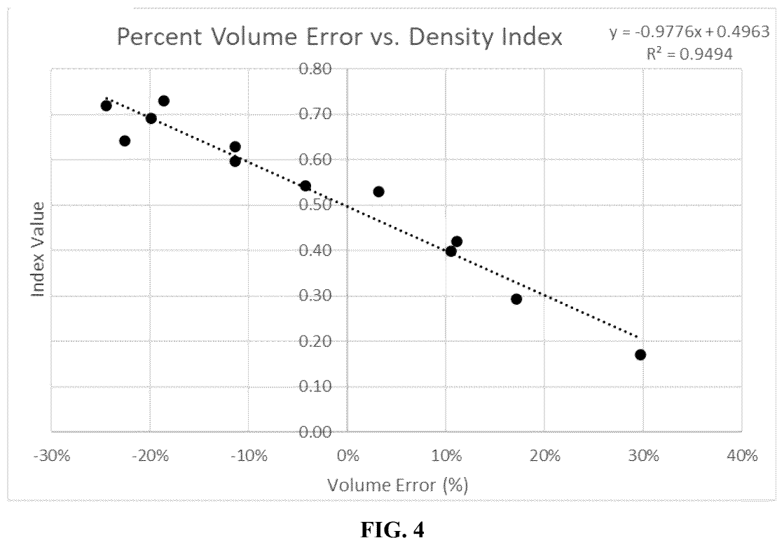

FIG. 4 illustrates the correlation between the determined material density index value in step 208 and the percent mass estimate error (volumetric-based) of the mixture of trash 104″ and harvested crop 104′ entering the collection location/bin 117. FIG. 4 illustrates the determined material density index value in step 208 as the y axis, and the percent mass error of the mixture of trash 104″ and harvested crop 104′ entering the collection location/bin 117 as the x axis, which when can be linearly fit to represent a relationship between the two variables.

Systems, apparatuses, and methods described herein may be implemented using digital circuitry, or using one or more computers using well-known computer processors, memory units, storage devices, computer software, and other components, as illustrated in FIG. 5 and discussed below. Typically, a computer includes a processor for executing instructions and one or more memories for storing instructions and data. A computer may also include, or be coupled to, one or more mass storage devices, such as one or more magnetic disks, internal hard disks and removable disks, magneto-optical disks, optical disks, etc.

Systems, apparatus, and methods described herein may be implemented using computers operating in a client-server relationship. Typically, in such a system, the client computers are located remotely from the server computer and interact via a network. The client-server relationship may be defined and controlled by computer programs running on the respective client and server computers.

Systems, apparatus, and methods described herein may be implemented within a network-based cloud computing system. In such a network-based cloud computing system, a server or another processor that is connected to a network communicates with one or more client computers via a network. A client computer may communicate with the server via a network browser application residing and operating on the client computer, for example. A client computer may store data on the server and access the data via the network. A client computer may transmit requests for data, or requests for online services, to the server via the network. The server may perform requested services and provide data to the client computer(s). The server may also transmit data adapted to cause a client computer to perform a specified function, e.g., to perform a calculation, to display specified data on a screen, etc. For example, the server may transmit a request adapted to cause a client computer to perform one or more of the steps of the methods and workflows described herein. Certain steps of the methods and workflows described herein may be performed by a server or by another processor in a network-based cloud-computing system. Certain steps of the methods and workflows described herein may be performed by a client computer in a network-based cloud computing system. The steps of the methods and workflows described herein may be performed by a server and/or by a client computer in a network-based cloud computing system, in any combination.

Systems, apparatus, and methods described herein may be implemented using a computer program product tangibly embodied in an information carrier, e.g., in a non-transitory machine-readable storage device, for execution by a programmable processor; and the method and workflow steps described herein may be implemented using one or more computer programs that are executable by such a processor. A computer program is a set of computer program instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

A high-level block diagram of such a computer is illustrated in FIG. 5. The computer of FIG. 5 can be wholly contained on the agricultural machine 100, remote from the agricultural machine 100, or partially remote and partially on the agricultural machine 100. Computer 502 contains a processor 504 which controls the overall operation of the computer 502 by executing computer program instructions which define such operation. The computer program instructions may be stored in a storage device 512, or other computer readable medium (e.g., magnetic disk, CD ROM, etc.), and loaded into memory 510 when execution of the computer program instructions is desired. Thus, the methods disclosed herein can be defined by the computer program instructions stored in the memory 510 and/or storage 512 and controlled by the processor 504 executing the computer program instructions.

Accordingly, by executing the computer program instructions, the processor 504 executes an algorithm disclosed herein. Processor 504 can be configured to execute computer program instructions for executing appropriate algorithms for controlling operation of the agricultural machine 100, and certain other data processing operations of the agricultural machine. Processor 504 can be configured to execute computer program instructions for executing appropriate algorithms for controlling operations of any or all components of the agricultural machine 100.

The computer 502 also includes one or more network interfaces 506 for communicating with other devices via a network. The computer 502 also includes input/output devices 508 that enable user interaction with the computer 502 (e.g., display, keyboard, mouse, speakers, buttons, etc.) One skilled in the art will recognize that an implementation of an actual computer could contain other components as well, and that FIG. 5 is a high level representation of some of the components of such a computer for illustrative purposes.

The foregoing Detailed Description is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the principles of the present invention and that various modifications may be implemented by those skilled in the art without departing from the scope and spirit of the invention. Those skilled in the art could implement various other feature combinations without departing from the scope and spirit of the invention.

1. A method for determining a material density of a harvested crop, the method comprising:
receiving a measurement of a first throughput signal;
receiving a measurement of a second throughput signal, wherein the second throughput signal is more sensitive to changes in material density than the first throughput signal;
comparing the first throughput signal to the second throughput signal; and
determining a material density index value based on the comparison of the first throughput signal to the second throughput signal.

2. The method of claim 1, wherein the first throughput signal is selected from the group consisting of a weight of the harvested crop at a location of an agricultural machine, a weight of the harvested crop at a collection location, a processing power of a component of the agricultural machine, and a hydraulic pressure of the component of the agricultural machine.

3. The method of claim 1, wherein the second throughput signal is selected from the group consisting of a volume throughput of the material at a location of an agricultural machine and a volume throughput of the material at a collection location.

4. The method of claim 1, wherein, prior to comparing the first throughput signal to the second throughput signal, the method further comprises:
removing a first free running offset of the first throughput signal; and/or
removing a second free running offset from the second throughput signal.

5. The method of claim 4, wherein
removing the first free running offset comprises calculating a derivative of the first throughput signal, and/or
removing the second free running offset comprises calculating a derivative of the second throughput signal.

6. The method of claim 1, wherein, prior to comparing the first throughput signal to the second throughput signal, the method further comprises:
extracting a first frequency range from the first throughout signal; and
extracting a second frequency range from the second throughput signal.

7. An agricultural machine for harvesting a material, the machine comprising:
a processor;
a memory to store computer program instructions, the computer program instructions when executed on the processor cause the processor to perform operations comprising:
receiving a measurement of a first throughput signal;
receiving a measurement of a second throughput signal, wherein the second throughput signal is more sensitive to changes in material density than the first throughput signal;
comparing the first throughput signal to the second throughput signal; and
determining a material density index value based on the comparison of the first throughput signal to the second throughput signal.

8. The machine of claim 7, wherein the processor is further configured to perform
automatically changing a delivered quantity of air based on the determined material density index value.

9. The machine of claim 7, wherein the processor is further configured to perform
receiving a waste signal, wherein when the waste signal indicates an output of the material, automatically reducing the delivered quantity of air.

10. The machine of claim 7, wherein the first throughput signal is selected from the group consisting of a weight of the harvested crop at a location of an agricultural machine, a weight of the harvested crop at a collection location, a processing power of a component of the agricultural machine, and a hydraulic pressure of the component of the agricultural machine.

11. The machine of claim 7, wherein the second throughput signal is selected from the group consisting of a volume throughput of the material at a location of an agricultural machine and a volume throughput of the material at a collection location.

12. The machine of claim 7, wherein the processor is further configured to perform, prior to comparing the first throughput signal to the second throughput signal,
removing a first free running offset of the first throughput signal; and/or
removing a second free running offset from the second throughput signal.

13. The machine of claim 12, wherein
removing the first free running offset comprises calculating a derivative of the first throughput signal, and/or
removing the second free running offset comprises calculating a derivative of the second throughput signal.

14. The machine of claim 7, wherein the processor is further configured to perform, prior to comparing the first throughput signal to the second throughput signal,
extracting a first frequency range from the first throughout signal; and
extracting a second frequency range from the second throughput signal.

15. An agricultural machine for harvesting a material, the machine comprising:
a waste sensor;
a fan;
a processor;
a memory to store computer program instructions, the computer program instructions when executed on the processor cause the processor to perform operations comprising:
receiving a measurement of a first throughput signal, the first throughput signal is selected from the group consisting of a weight of the harvested crop at a location of an agricultural machine, a weight of the harvested crop at a collection location, a processing power of a component of the agricultural machine, and a hydraulic pressure of the component of the agricultural machine;
receiving a measurement of a second throughput signal, wherein the second throughput signal is more sensitive to changes in material density than the first throughput signal, the second throughput signal is selected from the group consisting of a volume throughput of the material at a location of an agricultural machine and a volume throughput of the material at a collection location;
comparing the first throughput signal to the second throughput signal;
determining a material density index value based on the comparison of the first throughput signal to the second throughput signal; and
receiving a waste signal from the waste sensor that indicates an output of the material.

16. The machine of claim 15, wherein a delivered quantity of air is automatically changed based on the determined material density index value.

17. The machine of claim 15, wherein when the waste signal indicates an output of the material, a delivered quantity of air is automatically reduced.

18. The machine of claim 15, wherein the processor is further configured to perform, prior to comparing the first throughput signal to the second throughput signal,
removing a first free running offset of the first throughput signal; and/or
removing a second free running offset from the second throughput signal.

19. The machine of claim 18, wherein
removing the first free running offset comprises calculating a derivative of the first throughput signal, and/or
removing the second free running offset comprises calculating a derivative of the second throughput signal.

20. The machine of claim 15, wherein the processor is further configured to perform, prior to comparing the first throughput signal to the second throughput signal,
extracting a first frequency range from the first throughout signal; and
extracting a second frequency range from the second throughput signal.
